(19) United States
(12) Patent Application Publication
(10) Pub. No.: US 2020/0202384 A1
(43) Pub. Date: Jun. 25, 2020

(54) SECURE INTELLIGENT NETWORKED ARCHITECTURE WITH DYNAMIC FEEDBACK

(71) Applicant: Unearth Campaigns LLC, Sacramento, CA (US)

(72) Inventors: Bryan Merica, Sacramento, CA (US); Matthew Eagan, Stevensville, MD (US)

(21) Appl. No.: 16/681,627

(22) Filed: Nov. 12, 2019

Related U.S. Application Data
(60) Provisional application No. 62/783,772, filed on Dec. 21, 2018.

(51) Int. Cl. G06Q 30/02; H04L 29/08; H04W 4/14; H04W 4/23; G06N 7/00

(52) U.S. Cl. CPC G06Q 30/0245; H04L 67/10; G06N 7/005; H04W 4/23; H04W 4/14

(57) ABSTRACT

Provided herein are exemplary systems and methods including a secure intelligent networked architecture with dynamic feedback including an intelligent probabilistic influence server having a hardware processor and a memory for storing executable instructions, an interactive graphical user interface communicatively coupled over a network to the intelligent probabilistic influence server, a cloud resource communicatively coupled over the network to the intelligent probabilistic influence server and the interactive graphical user interface, the intelligent probabilistic influence server configured to receive from the interactive graphical user interface an indicator of a influencer target universe, identify on the network the influencer target universe, and store the influencer target universe.

### CROSS-REFERENCE TO RELATED APPLICATIONS

The present U.S. non-provisional patent application claims the priority benefit of U.S. provisional patent application Ser. No. 62/783,772 filed on Dec. 21, 2018 and titled, “Systems and Methods for Gathering, Storing, Targeting and Reporting on the Influencers that Impact the Opinion of Public Figures,” all of which is hereby incorporated by reference in its entirety.

### FIELD OF THE TECHNOLOGY

The present technology relates generally to a secure intelligent networked architecture with dynamic feedback for the identification of influencers that impact the opinion of a subject.

### SUMMARY OF THE PRESENT TECHNOLOGY

Provided herein are exemplary systems and methods including a secure intelligent networked architecture with dynamic feedback including an intelligent probabilistic influence server which may comprise a hardware processor and a memory for storing executable instructions, an interactive graphical user interface communicatively coupled over a network to the intelligent probabilistic influence server, a cloud resource communicatively coupled over the network to the intelligent probabilistic influence server and the interactive graphical user interface, the intelligent probabilistic influence server configured to receive from the interactive graphical user interface an indicator of a influencer target universe, identify on the network the influencer target universe; and store the influencer target universe.

Further embodiments include the intelligent probabilistic influence server further configured to upload the influencer target universe to a public digital media account, upload a test group larger than the influencer target universe, send public digital media ads to the test group larger than the influencer target universe, receive responses to the public digital media ads, and use the responses as dynamic feedback for the intelligent probabilistic influence server. Responses may include clicks, likes, shares, or comments. If the responses in general are positive, the intelligent probabilistic influence server may be further configured to send the public digital media ads to the influencer target universe. If the responses in general are negative, the intelligent probabilistic influence server may be configured to automatically change the public digital media ads. Additionally, if the responses in general are negative, the intelligent probabilistic influence server may also automatically change the test group to another test group.

Exemplary embodiments also include the intelligent probabilistic influence server configured to upload the influencer targeting universe to an email sending system, send emails to the influencer targeting universe, receive responses to the emails, and use the responses as dynamic feedback for the intelligent probabilistic influence server. The intelligent probabilistic influence server may also upload the influencer targeting universe to an SMS sending system, send SMS messages to the influencer targeting universe, receive responses to the SMS messages, and use the responses as dynamic feedback for the intelligent probabilistic influence server. The intelligent probabilistic influence server may also be configured to generate an interactive reporting dashboard in the form of a graphical user interface displaying campaign statistics for the public digital media ads, the emails and the SMS messages.

The secure intelligent networked architecture with dynamic feedback, according to various exemplary embodiments, may also include selecting the target universe based on a subject who is a person of interest, the selecting performed by the intelligent probabilistic influence server modeling influencer based files to predict a likelihood the target universe will interact positively with public digital media content. The intelligent probabilistic influence server may be further configured to upload the influencer target universe based on a subject who is a person of interest, send public digital media ads to the influencer target universe based on a subject who is a person of interest, receive responses to the public digital media ads, and use the responses as dynamic feedback for the intelligent probabilistic influence server. The responses may comprise clicks, likes, shares, or comments. If the responses in general are positive, the intelligent probabilistic influence server may be configured to send the public digital media ads to a selected influencer target universe comprising individuals who are connected to the subject such that they are likely to inform and/or impact the subject's opinion. The intelligent probabilistic influence server may also be configured to tag the subject in a public digital media post to create a direct notification with each interaction.

In yet further exemplary embodiments, the intelligent probabilistic influence server may be configured to generate an influencer audience around a subject by searching for input about a plurality of individuals, generate an initial matched universe, receive user input, and execute a media campaign. The intelligent probabilistic influence server may also be configured to utilize optimizing artificial intelligence to provide options for increased performance, receive a user selection of an option for increased performance and generate an interactive reporting dashboard in the form of a graphical user interface. The intelligent probabilistic influence server may also use artificial intelligence for issues comprising generating an initial universe of potential influencers by searching potential influencers on public digital media and 3rd party data sets, analyzing keywords to score a match with a topic tag and transmitting to artificial intelligence for connections to determine inclusion. The intelligent probabilistic influence server may be configured to utilize the artificial intelligence for connections by receiving user input on a match range, searching potential influencers on public digital media and third party data sets, scoring potential influencers based on tie strength, scoring potential influencers based on match confidence, generating net score factoring tie strength with match confidence, using match range to determine a minimum net score for selection, and generating a final influencer universe.

Furthermore, in many exemplary embodiments, the intelligent probabilistic influence server may utilize the optimizing artificial intelligence by receiving a plurality of metrics from public digital media platforms, receiving a plurality of metrics from digital ad platforms, receiving a plurality of metrics from email systems, receiving a plurality of metrics from SMS systems, analyzing the received metrics to determine performing creative and best performing platforms to load balance delivery across the influencer universe, generating recommended changes or automatically implementing changes according to user preferences, and monitoring the plurality of metrics periodically.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1A shows an exemplary system for secure intelligent networked architecture with dynamic feedback.

FIG. 1B shows an exemplary method for gathering, storing, targeting and reporting on the influencers that impact the opinion of a person of interest.

FIG. 2 shows an exemplary method for generating an influencer audience.

FIG. 3 shows an exemplary method of using artificial intelligence (“AI”) for issues.

FIG. 4 shows an exemplary method of using artificial intelligence (“AI”) for connections.

FIG. 5 shows an exemplary method of using artificial intelligence (“AI”) for optimal targeting.

FIG. 6 is a diagrammatic representation of another exemplary system.

### DETAILED DESCRIPTION

Advertisements, personal communications, and other messages continually bombard individuals online every day. This is especially true for a person of interest (the “Subject”) with a high public profile. Therefore, anyone trying to capture the attention of high-profile Subjects with an important message has difficulty breaking through and being heard.

According to various exemplary embodiments, messages may be targeted online through public digital media, email, digital advertisements, short message service (“SMS”) messages, and more, to not only the Subject of the communication, but also to a highly relevant list of other individuals that are known and closely connected to the Subject (“Influencers”), thereby increasing the likelihood that the Subject receives the message, if not directly, then indirectly, from the Influencers who have been targeted and choose to share the message with the Subject. A Subject is likely to notice a message targeted at him or her if others close to him or her shared the message. Various exemplary embodiments create an optimal targeting universe consisting of only those individuals mostly closely connected to the Subject: the Influencers.

Other online targeting methods target the Subject only directly, and/or use larger, less targeted universes of audiences. The various exemplary embodiments described herein intelligently identify and select the most relevant target universe required to most efficiently and effectively reach and impact the Subject and the Influencers.

Methods that only target the Subject are not utilizing the network of personal connections that are most likely to share a message with the Subject and have a much lower likelihood that the Subject will even notice the message. Other methods that only target much larger audiences are less efficient and therefore much more costly.

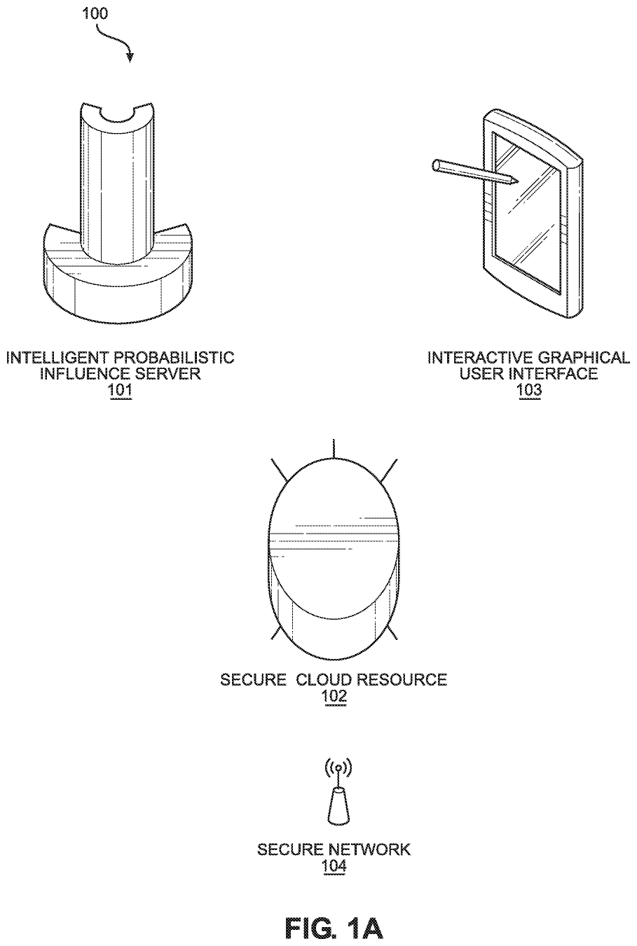

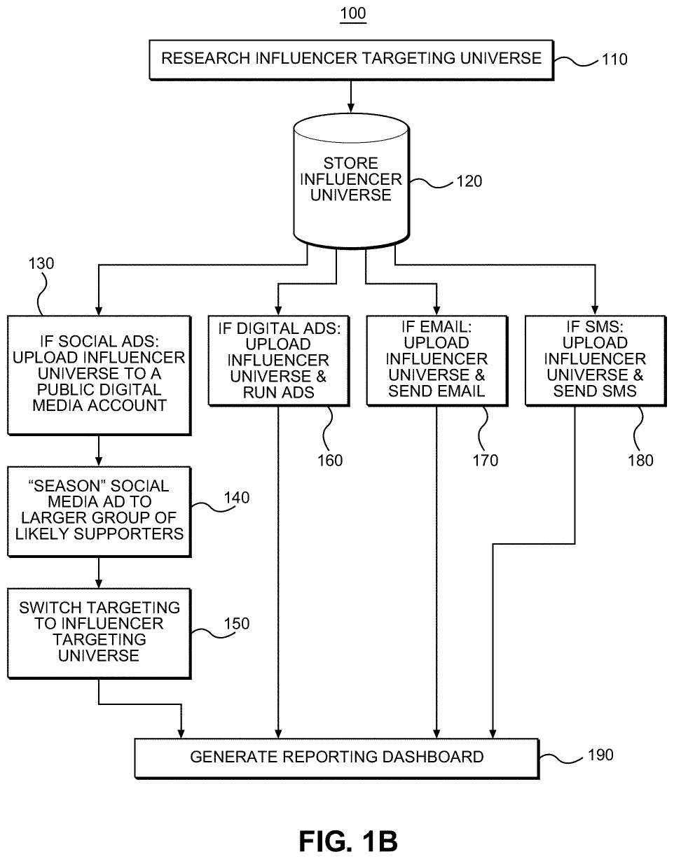

FIG. 1A is a diagram of an exemplary system 100 for secure intelligent networked architecture with dynamic feedback.

The exemplary system 100 as shown in FIG. 1A includes an intelligent probabilistic influence server 101 having a hardware processor and a memory for storing executable instructions, a secure cloud resource 102, an interactive graphical user interface 103, and a secure network 104.

The intelligent probabilistic influence server 101 having a hardware processor and a memory for storing executable instructions, according to some exemplary embodiments (although not limited to), is a non-generic computing device comprising non-generic computing components. It may comprise specialized dedicated hardware processors to determine and transmit digital data elements. In further exemplary embodiments, the intelligent probabilistic influence server 101 comprises a specialized device having circuitry, load balancing, and artificial intelligence, including machine dynamic learning. Numerous determination steps by the intelligent probabilistic influence server 101 as described herein may be made by an automatic machine determination without human involvement, including being based on a previous outcome or feedback (e.g. an automatic feedback loop) provided by the secure intelligent networked architecture, processing and/or execution as described herein.

The secure cloud resource 102, in some exemplary embodiments, may include specialized servers and/or virtual machines, and receive at least one digital data element from the intelligent probabilistic influence server 101.

According to various exemplary embodiments, a virtual machine may comprise an emulation of a particular computer system. Virtual machines operate based on the computer architecture and functions of a real or hypothetical computer, and their implementations may involve specialized hardware, software, or a combination of both.

The interactive graphical user interface 103, may include in certain exemplary embodiments, menu selections, icons, condensed information sets and a touchscreen. The interactive graphical user interface 103 may also dynamically display a specific, structured interactive graphical user interface, paired with a prescribed functionality directly related to the interactive graphical user interface's structure.

The secure network 104, in some exemplary embodiments, is any home, business, school, or other network that has security measures in place that help protect it from outside attackers.

FIG. 1B shows an exemplary method 100 for gathering, storing, targeting and reporting on the influencers that impact the opinion of people of interest.

At step 110, the influencer targeting universe is researched.

At step 120, the influencer targeting universe records are stored.

At step 130, if targeting in public digital media, the influencer targeting universe may be uploaded to a public digital media account.

At step 140, before running ads to the influencer universe, public digital media ads may be “seasoned” by sending them to a larger group of likely supporters to generate positive interactions on the public digital media post (e.g. clicks, likes, comments, shares, etc.).

At step 150, once an ad is “seasoned,” targeting may be switched to the influencer targeting universe.

At step 160, if targeting on a digital ad platform, the influencer targeting universe may be uploaded to an ad platform and ads begin to run to the influencer targeting universe.

At step 170, if targeting in email, the influencer targeting universe is uploaded to an email sending system and emails may be sent to the influencer targeting universe.

At step 180, if targeting in text (aka “SMS”), the influencer targeting universe may be uploaded to an SMS system and SMS messages may be sent to the influencer targeting universe.

At step 190, campaign statistics from the targeting platforms used in steps 160, 170 and/or 180 (above) may be entered into a reporting database to generate a reporting dashboard and/or an interactive graphical user interface.

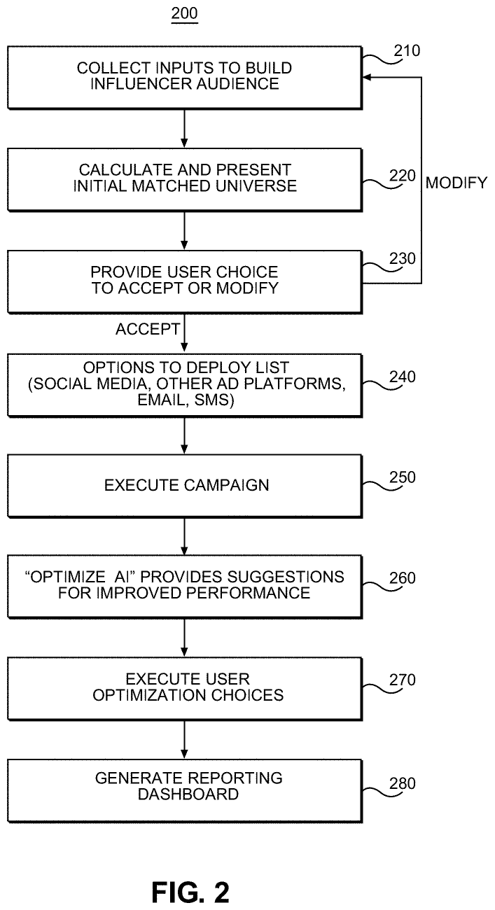

FIG. 2 shows an exemplary method 200 for generating an influencer audience.

At step 210, input may be automatically collected to build an influencer audience.

At step 220, an initial matched universe may be automatically calculated and presented.

At step 230, it may be automatically determined whether accept or modify the output of steps 210 and/or 220.

At step 240, if it is determined to accept the output of steps 310 and/or 320, an option may be automatically presented to automatically deploy a particular list (e.g. on public digital media, other ad platforms, email or SMS).

At step 250, a campaign may be automatically executed.

At step 260, optimized artificial intelligence may automatically provide suggestions for improved performance.

At step 270, one or more optimization choices may be automatically executed.

At step 280, a reporting dashboard may be automatically generated.

For example:

Input key data to build an influencer audience around a specific person of interest, the Subject:

Target Subject—Identifying Information:

name/city (at minimum)

email/public digital media accounts/phone number (for better matching)

more detail on prior employers/boards/other organizational affiliations (for best matching).

Topic Tag(s)—optional to increase relevance of selected Influencers to the subject matter of the communication. Tags may be selected from an existing taxonomy which the system's “Issue AI” may use to better match Influencers to the Subject.

Match Range—choose how broad or narrow of a universe for system's “Connections AI” to build (narrow is smaller, but more precise and closer connections . . . broad is larger and less precise and wider range of connections).

The various exemplary systems described herein may present an initial matched universe, including total universe size and universe size by category and sub-categories under each category.

The various exemplary systems described herein may accept the universe and proceed or return to provide more information and build out a more robust universe.

The various exemplary systems described herein may provide options for deploying the list to target the influencer audience:

Custom audiences on social networks such as Facebook, Instagram, Twitter, etc.;

Other digital ad platforms;

Email;

SMS.

The various exemplary systems described herein may select deployment options and proceed to execute paid targeting campaign.

System's “Optimize AI” may read campaign performance in real time and automatically provides suggestions for:

Matching best performing creative to each category and sub-category;

Expanding list universes in categories and subcategories that have low reach and engagement;

The system may automatically accept or reject suggestions or choose to Auto-Optimize.

The system may automatically provide a final performance report including reach and engagement by category and sub-category.

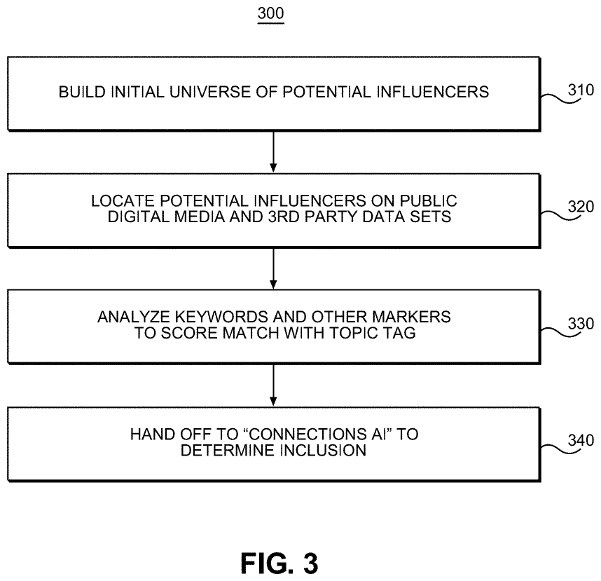

FIG. 3 shows an exemplary method 300 of using AI for issues.

At step 310, a universe of potential influencers may be automatically generated.

At step 320, potential influencers on public digital media and third party data sets may be automatically located.

At step 330, keywords and other markers may be automatically analyzed to score a match with a topic tag.

At step 340, connections artificial intelligence may be automatically used to determine inclusion.

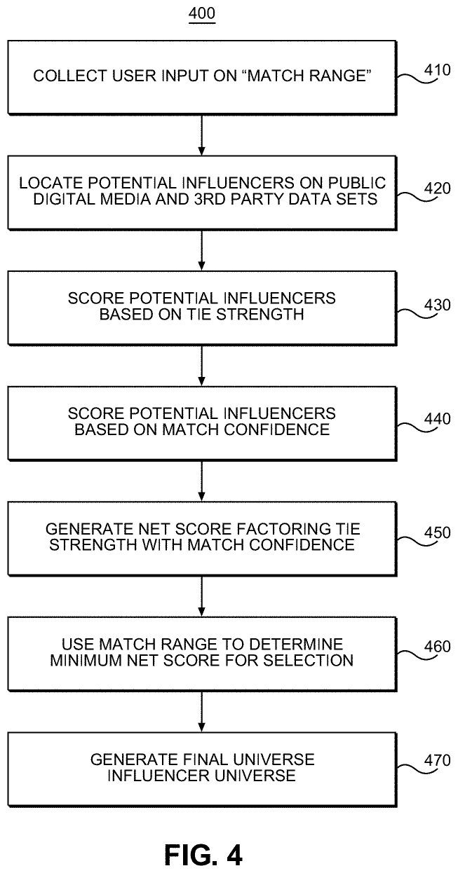

FIG. 4 shows an exemplary method 400 of using AI for connections.

At step 410, input may be automatically collected on a match range.

At step 420, potential influencers on public digital media and third party data sets may be automatically located.

At step 430, potential influencers may be automatically scored based on tie strength.

At step 440, potential influencers may be automatically scored based on match confidence.

At step 450, net score factoring may be automatically generated based on tie strength with match confidence.

At step 460, a match range may be used to determine minimum net score for selection.

At step 470, a final influencer universe may be automatically generated.

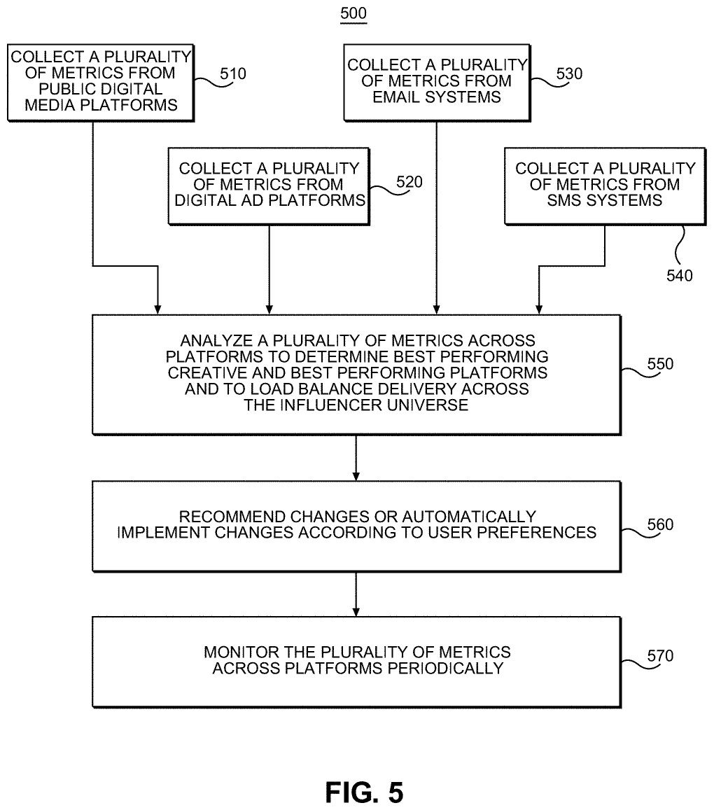

FIG. 5 shows an exemplary method 500 of using AI for optimal targeting.

At step 510, a plurality of metrics from public digital media platforms may be automatically collected.

At step 520, a plurality of metrics from digital ad platforms may be automatically collected.

At step 530, a plurality of metrics from email systems may be automatically collected.

At step 540, a plurality of metrics from SMS systems may be automatically collected.

At step 550, a plurality of metrics across platforms may be automatically analyzed to determine a best performing creative and best performing platforms and to load balance delivery across the influencer universe.

At step 560, changes may be automatically recommended and/or automatically implemented according to user preferences.

At step 570, the plurality of metrics may be automatically monitored across the platforms periodically.

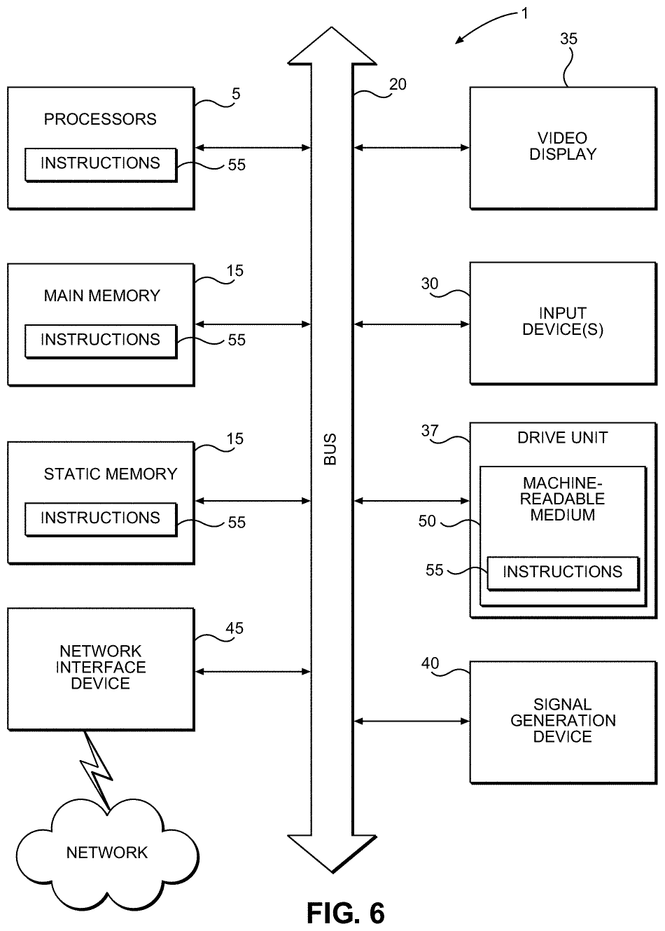

FIG. 6 is a diagrammatic representation of another exemplary system in the form of a computer system 1, within which a set of instructions for causing the machine to perform any one or more of the methodologies discussed herein may be executed. In various example embodiments, the machine operates as a standalone device or may be connected (e.g., networked) to other machines. It could be executed within a Customer Relations Management (“CRM”) system. In some cases, the systems and methods herein may send an API call to Salesforce or the like. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a smart speaker like Echo or Google Home, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The disk drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network (e.g., network 120) via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the present disclosure in the form disclosed. Many modifications and variations will be apparent to those of ordinary skill in the art without departing from the scope and spirit of the present disclosure. Exemplary embodiments were chosen and described in order to best explain the principles of the present disclosure and its practical application, and to enable others of ordinary skill in the art to understand the present disclosure for various embodiments with various modifications as are suited to the particular use contemplated.

Aspects of the present disclosure are described above with reference to flowchart illustrations and/or block diagrams of methods, apparatus (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The terminology used herein is for the purpose of describing particular embodiments only and is not intended to be limiting of the technology. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present disclosure. As such, some of the components may have been distorted from their actual scale for pictorial clarity.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/ or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel, or may be performed at different times.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A secure intelligent networked architecture with dynamic feedback comprising:
an intelligent probabilistic influence server having a hardware processor and a memory for storing executable instructions;
an interactive graphical user interface communicatively coupled over a network to the intelligent probabilistic influence server;
a cloud resource communicatively coupled over the network to the intelligent probabilistic influence server and the interactive graphical user interface;
the intelligent probabilistic influence server configured to:
receive from the interactive graphical user interface an indicator of a influencer target universe;
identify on the network the influencer target universe; and
store the influencer target universe.

2. The secure intelligent networked architecture with dynamic feedback of claim 1, the intelligent probabilistic influence server further configured to upload the influencer target universe to a public digital media account.

3. The secure intelligent networked architecture with dynamic feedback of claim 2, the intelligent probabilistic influence server further configured to upload a test group larger than the influencer target universe, send public digital media ads to the test group larger than the influencer target universe, receive responses to the public digital media ads, and use the responses as dynamic feedback for the intelligent probabilistic influence server.

4. The secure intelligent networked architecture with dynamic feedback of claim 3, the responses further comprising clicks, likes, shares, or comments.

5. The secure intelligent networked architecture with dynamic feedback of claim 4, if the responses in general are positive, the intelligent probabilistic influence server further configured to send the public digital media ads to the influencer target universe.

6. The secure intelligent networked architecture with dynamic feedback of claim 4, if the responses in general are negative, the intelligent probabilistic influence server further configured to automatically change the public digital media ads.

7. The secure intelligent networked architecture with dynamic feedback of claim 4, if the responses in general are negative, the intelligent probabilistic influence server further configured to automatically change the test group to another test group.

8. The secure intelligent networked architecture with dynamic feedback of claim 5, the intelligent probabilistic influence server further configured to upload the influencer targeting universe to an email sending system, send emails to the influencer targeting universe, receive responses to the emails, and use the responses as dynamic feedback for the intelligent probabilistic influence server.

9. The secure intelligent networked architecture with dynamic feedback of claim 8, the intelligent probabilistic influence server further configured to upload the influencer targeting universe to an SMS sending system, send SMS messages to the influencer targeting universe, receive responses to the SMS messages, and use the responses as dynamic feedback for the intelligent probabilistic influence server.

10. The secure intelligent networked architecture with dynamic feedback of claim 1, the intelligent probabilistic influence server further configured to generate an interactive reporting dashboard in the form of a graphical user interface displaying campaign statistics for the public digital media ads, the emails and the SMS messages.

11. The secure intelligent networked architecture with dynamic feedback of claim 1, further comprising selecting the target universe based on a subject who is a person of interest, the selecting performed by the intelligent probabilistic influence server modeling demographic based files to predict a likelihood the target universe will interact positively with public digital media content.

12. The secure intelligent networked architecture with dynamic feedback of claim 11, the intelligent probabilistic influence server further configured to upload the influencer target universe based on a subject who is a person of interest, send public digital media ads to the influencer target universe based on a subject who is a person of interest, receive responses to the public digital media ads, and use the responses as dynamic feedback for the intelligent probabilistic influence server, the responses further comprising clicks, likes, shares, or comments.

13. The secure intelligent networked architecture with dynamic feedback of claim 12, if the responses in general are positive, the intelligent probabilistic influence server further configured to send the public digital media ads to a selected influencer target universe comprising individuals who are connected to the subject such that they are likely to inform or impact the subject's opinion.

14. The secure intelligent networked architecture with dynamic feedback of claim 13, the intelligent probabilistic influence server further configured to tag the subject in a public digital media post to create a direct notification with each interaction.

15. The secure intelligent networked architecture with dynamic feedback of claim 1, the intelligent probabilistic influence server further configured to generate an influencer audience around a specific person of interest by searching for input about a plurality of individuals, generating an initial matched universe, receive user input, and executing a media campaign.

16. The secure intelligent networked architecture with dynamic feedback of claim 15, the intelligent probabilistic influence server further configured to utilize optimizing artificial intelligence to provide options for increased performance, receive a user selection of an option for increased performance and generate an interactive reporting dashboard in the form of a graphical user interface.

17. The secure intelligent networked architecture with dynamic feedback of claim 16, the intelligent probabilistic influence server further configured to use artificial intelligence for issues comprising generating an initial universe of potential influencers by searching potential influencers on public digital media and 3rd party data sets, analyzing keywords to score a match with a topic tag and transmitting to artificial intelligence for connections to determine inclusion.

18. The secure intelligent networked architecture with dynamic feedback of claim 17, the intelligent probabilistic influence server further configured to utilize the artificial intelligence for connections by receiving user input on a match range, searching potential influencers on public digital media and third party data sets, scoring potential influencers based on tie strength, scoring potential influencers based on match confidence, generating net score factoring tie strength with match confidence, using match range to determine a minimum net score for selection, and generating a final universe influencer universe.

19. The secure intelligent networked architecture with dynamic feedback of claim 17, the intelligent probabilistic influence server further configured to utilize the optimizing artificial intelligence by receiving a plurality of metrics from public digital media platforms, receiving a plurality of metrics from digital ad platforms, receiving a plurality of metrics from email systems, receiving a plurality of metrics from SMS systems, analyzing the received metrics to determine performing creative and best performing platforms to load balance delivery across the influencer universe, generating recommended changes or automatically implementing changes according to user preferences, and monitoring the plurality of metrics periodically.
